(19) United States
(12) Patent Application Publication
(10) Pub. No.: US 2025/0135420 A1
(43) Pub. Date: May 1, 2025

(54) REPTILE CRICKET POWDER MIXER

(71) Applicant: Dong Guan ETAN Pet Supplies Co., Ltd, Dongguan (CN)

(72) Inventor: HONGQI CHEN, Dongguan (CN)

(21) Appl. No.: 18/926,808

(22) Filed: Oct. 25, 2024

(30) Foreign Application Priority Data
Nov. 1, 2023 (CN) 202322955762.4

(51) Int. Cl. B01F 35/71; A23K 20/24; A23K 50/00; A23N 17/00; B01F 23/60; B01F 33/501; B01F 101/18

(52) U.S. Cl. CPC B01F 35/718051; A23K 20/24; A23K 50/00; A23N 17/007; B01F 23/60; B01F 33/50111; B01F 2101/18

(57) ABSTRACT

This disclosure presents a reptile cricket powder mixer, which comprises a shell, including a primary shell with primary through-holes provided on its lower surface at an interval and a secondary shell which is movably mounted at the lower end of the primary shell and is used to store calcium powder; an upper cover, which is mounted at the upper end of the primary shell; a powder adjusting ring, which is fixed inside the secondary shell, and secondary through-holes are provided on the surface of the ring at an interval aligned with the primary through-holes. In this disclosure, by rotating the secondary shell, you can change the area of alignment of the primary through-holes with the secondary through-holes, so as to control the quantity of the powder entering to or from the first or the secondary shell, or to conveniently recycle any excessive powder in the primary shell.

### CROSS-REFERENCE TO RELATED APPLICATIONS

This application claims priority to Chinese Patent Application No. 202322955762.4, filed on Nov. 1, 2023, which is hereby incorporated by reference in its entirety.

### TECHNICAL FIELD

This disclosure relates to the technical field in pet feeding, in particular to a reptile cricket powder mixer.

### BACKGROUND

There are very few tanks or containers available on the market for calcium regulation for pets. Most of the calcium regulation tanks using the existing technology are to directly import two types of feeds into it, covered with a lid, and to mix them with mixing device.

For example, an existing pet feeder, which includes a cylinder, and on the inner wall of the cylinder there is a cover plate in sealed contact. On the top of the cover plate there is a rotating hole, and inside the rotating hole there is a rotating shaft fixed. On the external side of the rotating shaft are fixed a number of mixing blades. On the top of the cover plate is fixed two lap plates, and on the bottom of the lap plates are fixed rectangular plate. On the top of the cylinder there are two rectangular grooves, which couple with the rectangular plate. On the bottom of the rectangular plate is provided bottom slot. An inner slot is provided on the top inner wall of the bottom slot. The inner slot is furnished with an inner shaft. The outer bottom of the inner shaft is connected with a pressing plate. The top inner wall of the bottom slot is provided with a moving slot, in which a moving plate is mounted. The bottom of the moving plate is securely connected with a pull plate. The outer fixing sleeve of the inner shaft is equipped with a gear, and the front side of the pull plate is securely connected with a gear rack, which couples with the gear. Both sides of the two moving plates close to each other are welded with springs, and the ends of the two springs close to each other are welded to the inner wall of the side of the two moving slots close to each other. The inner wall of the two bottom slots close to each other is securely connected with a stability plate. The inner wall of the bottom of the rectangular groove is securely connected with an L-shaped frame. The top of the clamping plate is in contact with the L-shaped frame. The inner wall of the bottom of the rectangular groove is securely connected with a drive motor. The output shaft of the drive motor is securely connected with a concentric shaft, and the top of the concentric shaft is securely connected with a square plate. The bottom end of the inner shaft is provided with a square slot, which couples with the square plate.

The portable pet feeder enables the cover plate tightly mounted to the cylinder by driving the motor, but there are spaces for improvement. For example, before mixing two types of pet feeds, it is necessary to prevent one type of feed from being overdosed, but the portable pet feeder can only directly put the pet feed required into the cylinder for mixing, and the feed in proper quantity has to be prepared in advance for each feeding. If the quantity of feed is Insufficient in operation, it is necessary to add feed to the cylinder through a complex procedure. That is, it cannot easily control the amount of pet feed. And if a type of pet feed is excessive, it is inconvenient to recycle it (i.e., every time you recycle excessive feed, you have to turn on the drive motor repeatedly to take away the cover plate and then take out the excessive feed).

So it is necessary to invent a feeder that can control the quantity of feed in and out and easily recycle any excessive feed.

### SUMMARY

In view of the problems existing in the current technology as stated above, this disclosure aims to provide a cricket powder mixer, which comprises an upper cover, a primary shell and a secondary shell installed in turn, a number of primary through-holes arranged on the lower surface of the primary shell, a powder discharge adjusting ring fixed on the inner side of the secondary shell, and secondary through-holes arranged on the powder discharge adjusting ring to couple with the primary through-holes. When the secondary shell is rotated, the area of alignment between the two groups of through-holes will be changed, so as to control the quantity of the powder entering from the secondary shell into the primary shell when the cricket mixed is overturned. In addition, when there is any excess powder, it can also be conveniently returned to the secondary shell.

In order to achieve the aforesaid goal, this disclosure offers:

a reptile cricket powder mixer, which comprises the shells, including the primary shell with the primary through-holes provided on its lower surface at an interval, and the secondary shell which is movably mounted at the lower end of the primary shell and used to store calcium powder; an upper cover, which is mounted at the upper end of the primary shell; a powder adjusting ring, which is fixed in the secondary shell interior, and in which secondary through-holes are provided. When rotating the secondary shell, you can change the area of alignment of the primary through-holes with the secondary through-holes, so as to control the quantity of the powder entering to or from the first or the secondary shell.

Furthermore, the secondary shell comprises a powder adjusting shell and a powder storage tank. The powder adjusting shell is in a hollow structure. The upper end of the powder adjusting shell is movably mounted to the lower end of the primary shell, and the powder storage tank is fixed to the lower end of the powder adjusting shell. The powder adjusting ring is fixed inside the powder adjusting shell, and is in contact with the lower surface of the primary shell. By rotating the powder adjusting shell, the powder adjusting ring can be driven to rotate, so that the coincidence area of the second through hole and the first through hole can be changed.

Furthermore, the powder storage tank is arranged at the lower end of the powder adjusting shell, and the powder storage tank is threaded with the lower end of the powder adjusting shell.

Furthermore, the inner side of the powder adjusting shell is provided with a clamp block extending along both sides, and the outer side of the lower end of the primary shell is provided with a clamp slot coupled with the clamp block. By coupling the blocks with the slots, you can movably mount the powder adjusting shell to the lower end of the primary shell.

Furthermore, the upper end of the powder adjusting shell is fixed at the lower end of the primary shell, and a switching clamp block is provided on the inner side of the upper end of the powder adjusting shell. A primary switching clamp slot and a secondary switching clamp slot are provided horizontally on the outer side of the lower end of the primary shell. By rotating the powder adjusting shell, you can couple the switching clamp blocks with the primary and secondary clamp slots. The area of alignment between the two groups of through-holes can be changed or fixed through such structure.

Furthermore, the outer side of the powder adjusting shell is provided with a number of anti-slip strips. The anti-slip strip enables the user to more conveniently rotate the powder adjusting shell.

Furthermore, an arc-shaped primary limit block is provided on the lower surface of the primary shell. An arc-shaped primary limit slot is provided on the surface of the powder adjusting ring. The primary limit block is movably embedded into the primary limit slot. By rotating the powder adjusting shell, you can move the primary limit block in the primary limit block, so as to control the alignment of the primary through-holes with the second through-holes.

Furthermore, the surface of the upper cover is provided with a rotatable sheet and an opening through the upper and lower sides and matched with the rotating plate. The rotatable sheet is movably connected with the upper cover and can be mounted onto the opening. By rotating the rotatable sheet, you can change the size of the opening.

Furthermore, in the center of the upper cover there is a circular cavity through the upper and lower sides. Two convex blocks are arranged on the rotatable sheet, and can be fixed through the circular cavity. The rotatable sheet can be rotated around the circular cavity through the two convex blocks. The inner side of the circular cavity is concave to form a number of positioning slots, and on the surface of the two convex blocks there are positioning blocks, which can be correspondingly embedded into the positioning slots. Through such structure, the positioning block can be selectively connected with the positioning slot, so as to accurately control the size of the opening.

Furthermore, the rotatable sheet and the opening are in semicircular shape. On the surface of the upper cover there is a secondary limit block located on one side of the rotatable sheet. By rotating the rotatable sheet, the secondary limit block can be pressed against the first end or the second end of the flat side of the rotatable sheet.

This disclosure has the following beneficial effect:

This disclosure changes the overlapping area of the primary and the secondary through-holes by rotating the powder adjusting shell, so as to control the amount of powder flowing from the powder storage tank into the primary shell, and the cricket can be put into the primary shell through the upper cover, and user can shake the disclosure to make the cricket and powder mix evenly. After shaking, if there is any excess powder, user can rotate the powder adjusting shell to increase the overlapping area of the two groups of through holes, so that the powder can be returned to the powder storage tank.

### BRIEF DESCRIPTION OF DRAWINGS

FIG. 1 presents the overall structure of the disclosure.

FIG. 2 displays the overall structure explosive view of the disclosure.

FIG. 3 gives a structural diagram of the primary shell of the disclosure.

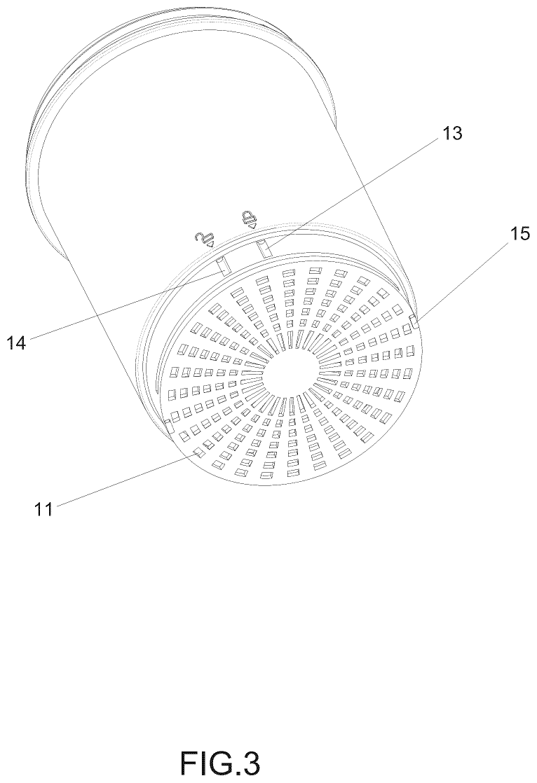

FIG. 4 is the structure diagram of the powder discharge adjusting shell of the disclosure.

FIG. 5 is a structural explosion diagram of the upper cover of the disclosure.

FIG. 6 shows a section diagram of the overall structure of the disclosure.

FIG. 7 provides an example diagram of the disclosure in operation.

### LABELS IN ILLUSTRATIONS

1. Primary shell; 11. The primary through-holes; 12. Clamp slot; 13. The primary switching clamp slot; 14. The secondary switching clamp slot; 15. The primary limit block;
2. The secondary shell;
3. The upper cover; 31. The rotating sheet; 311. The primary pull block; 312. The secondary pull block; 32. The opening; 33. The circular cavity; 34. The convex block; 35. The positioning slot; 36. The positioning block; 37. The secondary limit block;
4. The powder adjusting shell; 41. The powder adjusting ring; 411. The primary limit slot; 42. The secondary through-holes; 43. The clamp block; 44. The switching clamp block; 45. The non-slip strips;
5. The powder storage tank.

### DESCRIPTION OF EMBODIMENTS

This disclosure is further elaborated in combination with the attached illustrations and specific embodiments below. The following description is only illustrative and does not limit the scope of protection of the disclosure.

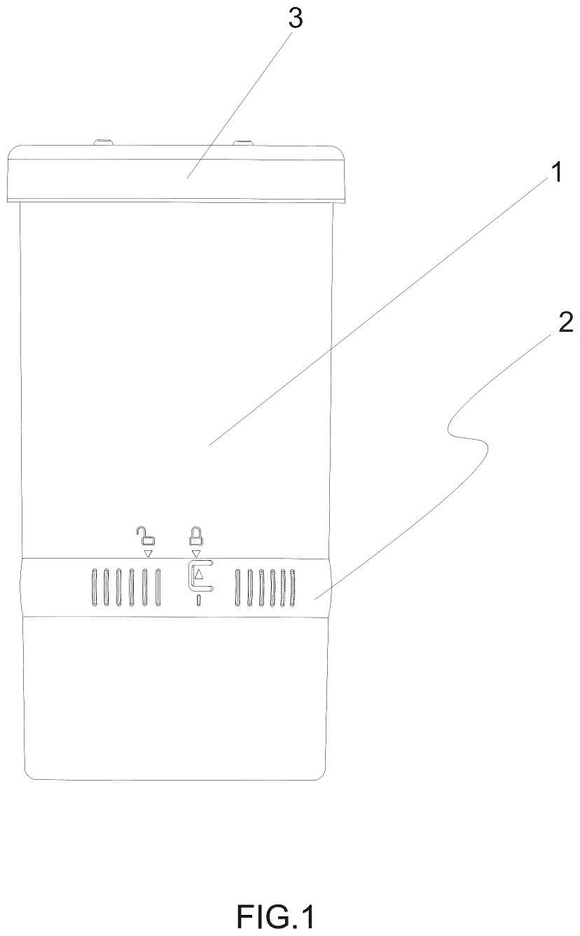

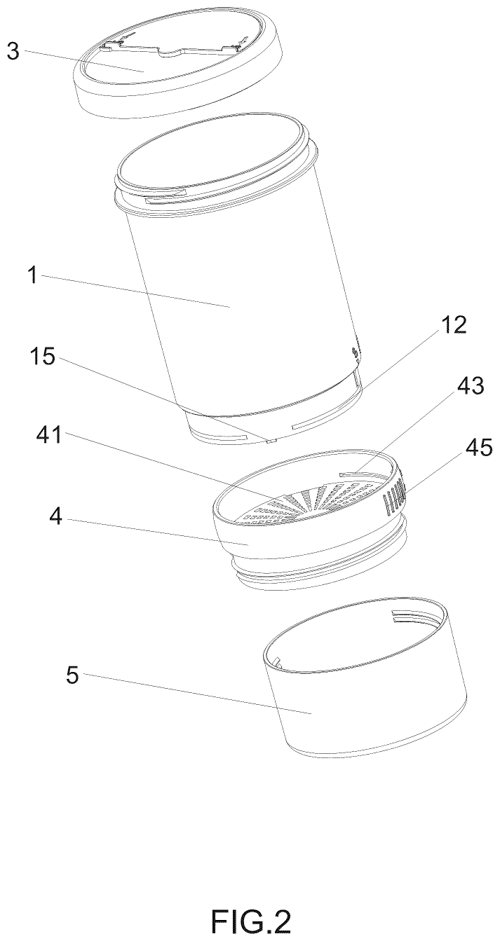

As shown in FIG. 1 and FIG. 2, a cricket powder mixer comprises a shells, including a primary shell 1 and a secondary shell 2. In the present embodiment, the secondary shell 2 further comprises a powder discharge adjusting shell 4 and a powder storage tank 5 threaded with the powder discharge adjusting shell 4. The powder storage tank 5 is used for store calcium powder. Powder adjusting shell 4 is in hollow structure and the inner side of powder adjusting shell 4 is provided with a clamp block 43 extending along the both sides. Correspondingly, the outer side of the lower end of the primary shell 1 is provided with clamp slot 12, and the clamp block 43 can couple with the clamp slot 12 to enable the powder adjusting shell 4 to rotate on the lower end of the primary shell 1.

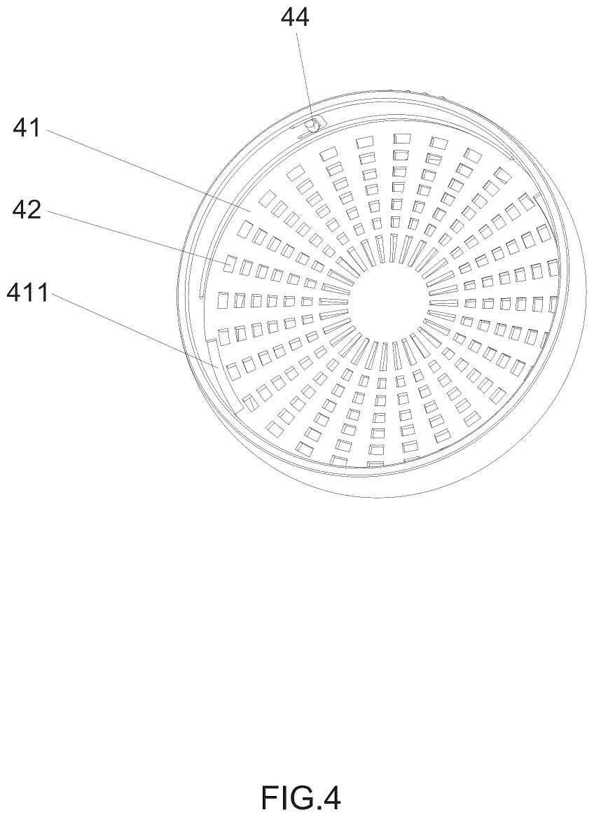

As shown in FIG. 2˜ FIG. 4, an integrated powder adjusting ring 41 is provided inside the powder control shell 4. A number of secondary through-holes 42 are arranged on the surface of the powder adjusting ring 41, and a number of primary through-holes 11 which are the same size and quantity as the secondary through-holes 42 are arranged at intervals on the lower surface of the primary shell 1. When the clamp block 43 is connected with the clamp slot 12, the upper end of the powder adjusting shell 4 is set on the lower end of the primary shell 1, and the lower surface of the primary shell 1 will be in contact with the powder adjusting ring 41, that is, the primary through-holes 11 and the secondary through-holes 42 are also straight-through to prevent powder scattered in the gap between the two groups of through-holes.

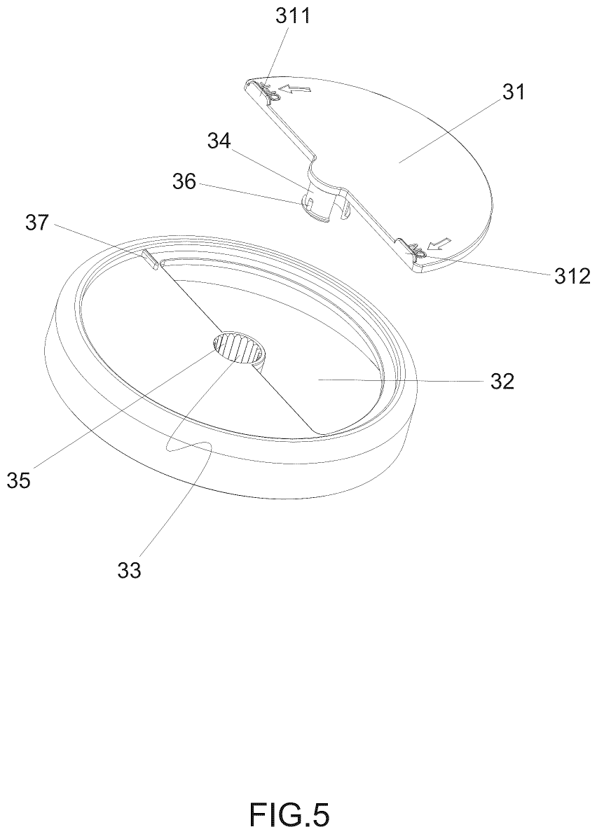

As shown in FIG. 1˜ FIG. 5, the cricket powder mixer also comprises an upper cover 3, which is threaded to the upper end of the first housing 1. When in use, the upper cover 3 can be opened first, and the cricket is put into the primary shell 1, and then the upper cover 3 is closed. When the powder adjusting shell 4 is rotated, and the powder adjusting ring 41 will rotate with the powder adjusting shell 4 until the area of alignment between the primary through-holes 11 and the secondary through-holes 42 changes, and then the calcium powder will be transported from the powder storage tank 5 to the primary shell 1. When the quantity of calcium powder into the primary shell 1 is sufficient, user can rotate the powder adjusting shell 4 in the opposite direction, so that the primary through-holes 11 and the secondary through-hole 42 are completely misaligned, that is, the primary shell 1 is enclosed at this moment. By shaking the cricket powder mixer user can fully mix calcium powder and cricket. When fully shaken, if there is still calcium powder remaining in the primary shell 1, just turn the powder discharge adjusting shell 4 again to so that the calcium powder in the primary shell 1 flows back into the powder storage tank 5.

As shown in FIGS. 2˜4, in the present embodiment, on the inner side of the upper end of the powder adjusting shell 4 there is an integrated switching clamp block 44, and correspondingly, a primary switching clamp slot 13 and a secondary switching clamp slot 14 in the same size of the switching clamp block 44 are arranged horizontally on the outer side of the lower end of the primary shell 1, respectively. In the natural state, the switching clamp block 44 tightly couples with the primary switching clamp slot 13, and at this moment the primary through-holes 11 and the secondary through-holes 42 are in a completely misaligned state (that is, calcium powder cannot enter the primary shell 1). When the switching clamp block 44 is slowly rotated into the second switching clamp slot 14 and couple in tightly, the primary through-holes 11 and the secondary through-holes 42 also slowly align with each other. At this moment, calcium powder will enter the primary shell 1 from the powder storage tank 5.

As shown in FIG. 2, preferably, a number of non-slip strips 45 are arranged on the surface of the powder adjusting shell 4, through which user can easily rotate the powder adjusting shell 4.

As shown in FIGS. 2˜4, in the current embodiment, two integrated arc-shaped primary limit blocks 15 are provided on the lower surface of the primary shell 1. Correspondingly, an arc-shaped primary limit slot 411 in the same quantity and size of the primary limit block 15 is provided on the surface of the powder discharge adjusting ring 41. When the powder discharge adjusting shell 4 is mounted to the primary shell 1, The primary limit block 15 will be clamped into the primary limit slot 411 and can be moved along the primary limit slot 411. The limit slot and limit block are arranged so as to be used in conjunction with switching clamp block 44. Specifically, when the switching clamp block 44 is rotated from the primary switching clamp slot 13 to the secondary switching clamp slot 14, the primary limit block 15 will move from one end of the primary limit slot 411 to the other end of the primary limit slot 411, so as to precisely control the extent of alignment between the primary through-holes 11 and the secondary through-holes 42.

As shown in FIGS. 2 and 5, in the current embodiment, the surface of the upper cover 3 is provided with a rotatable sheet 31 and an opening 32 through the upper and lower sides, and the rotatable sheet 31 is in the same size of the opening 32. The rotatable sheet 31 can couple with the opening 32. The upper cover 3 is also provided with a circular cavity 33 through the upper and lower sides. The inner side of the circular cavity 33 is concave to form a number of vertically extended positioning slots 35. The bottom of the rotating plate 31 is furnished with two integrated convex blocks 34. The surface of the two convex blocks 34 are provided with integrated positioning block 36. Two convex blocks 34 is arranged through the circular cavity 33. At this moment positioning block 36 will jam positioning slot 35. Based on the aforesaid structure, the rotatable sheet 31 can rotate through the two convex blocks 34 and around the circular cavity 33 as the center to change the size of the opening 32. When in use, if the rotatable sheet 31 is rotated continuously, the positioning block 36 will be successively embedded into the adjacent positioning slot 35, so as to precisely control the size of the opening 32. After stopping pulling the rotatable sheet 31, as the positioning block 36 is engaged with the relevant positioning slot 35, the rotatable sheet 31 will not move freely at this moment, so that the opening 32 can be maintained at the current size of aperture.

In this embodiment, both the rotatable sheet 31 and the opening 32 are semi-circular, and the surface of the upper cover 3 is provided with a secondary limit block 37 located on one side of the rotatable sheet 31. In natural state, the secondary limit block 37 is pressed against the primary end of the flat side of the rotatable sheet 31. At this moment, the rotatable sheet 31 and the opening 32 are completely aligned with each other (that is, the cricket powder mixer is enclosed). When the rotatable sheet 31 rotates to a certain degree, the rotatable sheet 31 will gradually move away from the opening 32 (that is, the opening 32 will gradually become larger), until the secondary limit block 37 meets the secondary end of the flat side of the rotatable sheet 31. At this moment, the rotatable sheet 31 and the opening 32 are completely misaligned with each other (that is, the opening 32 is in the maximum aperture). Similarly, the rotatable sheet 31 can be turned in the opposite direction to return to the position in the natural state (that is, the rotatable sheet 31 and the opening 32 are completely aligned with each other).

Preferably, as shown in FIG. 5, the primary pull block 311 and a secondary pull block 312 are arranged on the surface of the rotatable sheet 31, and the primary pull block 311 and the secondary pull block 312 are arranged at intervals along the length direction of the flat side of the rotatable sheet 31. User can push the primary pull block 311 and the secondary pull block 312 so as to turn the rotatable sheet 31 easily.

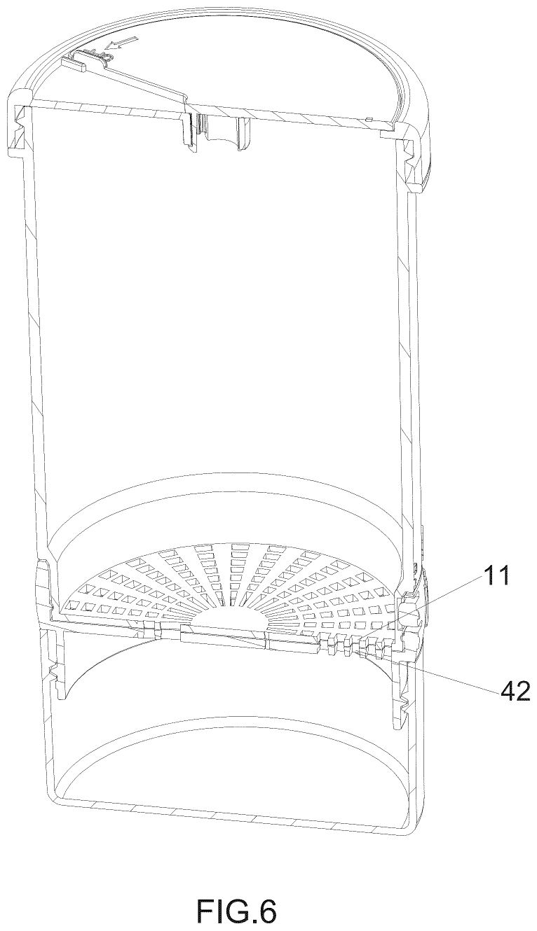

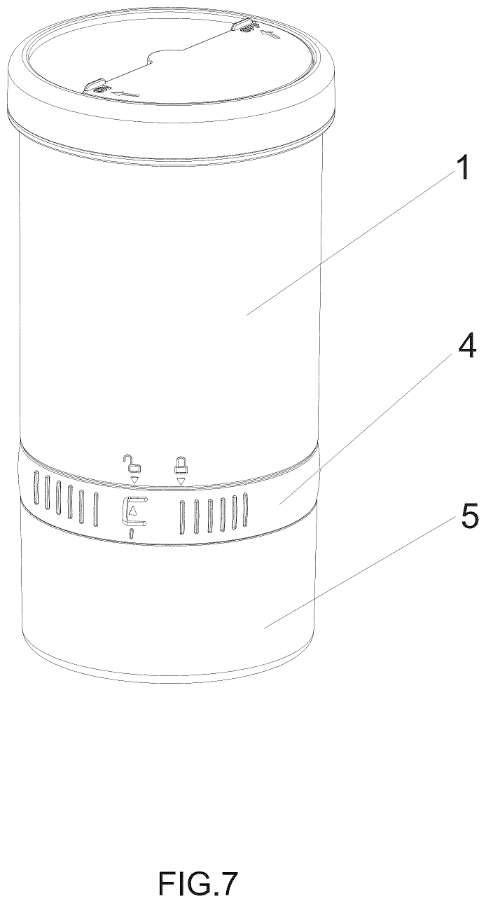

In the following paragraphs, as shown in FIG. 6 and FIG. 7, the specific application principle of the disclosure will be described for clear understanding of the disclosure.

In the natural state, the switching clamp block 44 is stuck to the primary switching clamp slot 13. At this moment, the primary through-holes 11 and the secondary through-holes 42 are completely misaligned (that is, calcium powder cannot be transported from the powder storage tank 5 to the primary shell 1). User first turns the rotatable sheet 31 to extend the opening 32 of the upper cover 3 until a cricket can be put in. After the cricket is put in, it will fall into the primary shell 1. Next, rotate the powder discharge adjusting shell 4, so that the switching clamp block 44 rotates from the primary switching clamp slot 13 to the secondary switching clamp slot 14 and snaps the secondary switching clamp slot 14 (the position of the disclosure is as shown in FIG. 7). In this process, the primary through-holes 11 and the secondary through-holes 42 will gradually aligned with each other (that is, as shown in FIG. 6, the area of alignment of the primary through-holes 11 with the secondary through-holes 42 gradually increases and finally they completely aligned), and then overturn the cricket powder mixer so that calcium powder can flow into the primary shell 1 from the powder storage tank 5. That is, the area of alignment between the primary through-holes 11 and the secondary through-holes 42 will be changed by rotating the powder adjusting shell 4 so as to control the quantity of calcium powder that is delivered. Next, turn the powder adjusting shell 4 in the opposite direction so that the two groups of holes are completely misaligned (i.e., the calcium powder cannot flow to or from the powder storage tank 5 or the primary shell 1), so that user can shake the primary shell 1 to mix the cricket and calcium powder adequately. Next, if there is still excess calcium powder left in the primary shell 1, user can turn the powder adjusting shell 4 so that the calcium powder in the primary shell 1 falls back into the powder storage tank 5.

This disclosure is not limited to the aforesaid embodiments, and it will contain any proper variations or variants, only if these variations or variants do not deviate from the principle and scope of this disclosure, and fall into the scope of these claims and the equivalent technology for this disclosure.

What is claimed is:

1. A reptile cricket powder mixer, which features:
the shells, including the primary shell with the primary through-holes provided on its lower surface at an interval, and the secondary shell which is movably mounted at the lower end of the primary shell and used to store calcium powder;
an upper cover, which is mounted at the upper end of the primary shell;
a powder adjusting ring, which is fixed in the secondary shell interior, and in which secondary through-holes are provided;
When rotating the secondary shell, you can change the area of alignment of the primary through-holes with the secondary through-holes, so as to control the quantity of the powder entering to or from the first or the secondary shell.

2. The cricket powder mixer according to claim 1:
The secondary shell comprising a powder adjusting shell and a powder storage tank;
The powder adjusting shell is in a hollow structure, The upper end of the powder adjusting shell is movably mounted to the lower end of the primary shell, and the powder storage tank is fixed to the lower end of the powder adjusting shell;
The powder adjusting ring is fixed inside the powder adjusting shell, and is in contact with the lower surface of the primary shell;
By rotating the powder adjusting shell, the powder adjusting ring can be driven to rotate, so that the coincidence area of the second through hole and the first through hole can be changed.

3. The cricket powder mixer according to claim 2:
The powder storage tank is arranged at the lower end of the powder adjusting shell, and the powder storage box is threaded with the lower end of the powder adjusting shell.

4. The cricket powder mixer according to claim 2:
On the inner side of the upper end of the powder adjusting shell are provided clamping blocks extending along the direction of both sides;
On the outer side of the lower end of the primary shell are provided clamping slots coupled with the clamping blocks;
By coupling the blocks with the slots, you can movably mount the powder adjusting shell to the lower end of the primary shell.

5. The cricket powder mixer according to claim 4:
The upper end of the powder adjusting shell is fixed at the lower end of the primary shell, and a switching clamp block is provided on the inner side of the upper end of the powder adjusting shell;
A primary switching clamp slot and a secondary switching clamp slot are provided horizontally on the outer side of the lower end of the primary shell;
By rotating the powder adjusting shell, you can couple the switching clamp blocks with the primary and secondary clamp slots.

6. The cricket powder mixer according to claim 2:
A non-slip strip is provided on the outer side of the powder adjusting shell;
The anti-slip strip enables the user to more conveniently rotate the powder adjusting shell.

7. The cricket powder mixer according to claim 2:
An arc-shaped primary limit block is provided on the lower surface of the primary shell;
An arc-shaped primary limit slot is provided on the surface of the powder adjusting ring;
The primary limit block is movably embedded into the primary limit slot;
By rotating the powder adjusting shell, you can move the primary limit block in the primary limit block, so as to control the alignment of the primary through-holes with the second through-holes.

8. The cricket powder mixer according to claim 1:
The surface of the upper cover is provided with a rotatable sheet and an opening through the upper and lower sides and matched with the rotating plate;
The rotatable sheet is movably connected with the upper cover and can be mounted onto the opening;
By rotating the rotatable sheet, you can change the size of the opening.

9. The cricket powder mixer according to claim 8:
In the center of the upper cover there is a circular cavity through the upper and lower sides;
Two convex blocks are arranged on the rotatable sheet, and can be fixed through the circular cavity. The rotatable sheet can be rotated around the circular cavity through the two convex blocks;
The inner side of the circular cavity is concave to form a number of positioning slots, and on the surface of the two convex blocks there are positioning blocks, which can be correspondingly embedded into the positioning slots.

10. The cricket powder mixer according to claim 9:
The rotatable sheet and the opening are in semicircular shape;
On the surface of the upper cover there is a secondary limit block located on one side of the rotatable sheet;
By rotating the rotatable sheet, the secondary limit block can be pressed against the first end or the second end of the flat side of the rotatable sheet.
